(19) United States
(12) Patent Application Publication
(10) Pub. No.: US 2024/0348107 A1
(43) Pub. Date: Oct. 17, 2024

(54) ELECTRONIC DEVICE AND METHOD FOR MULTI-COIL-BASED WIRELESS POWER TRANSMISSION BY ELECTRONIC DEVICE

(71) Applicant: Samsung Electronics Co., Ltd., Suwon-si (KR)

(72) Inventors: Seungshik SHIN, Suwon-si (KR); Baewon PARK, Suwon-si (KR); Sungchul PARK, Suwon-si (KR); Jinsik CHOI, Suwon-si (KR)

(21) Appl. No.: 18/753,607

(22) Filed: Jun. 25, 2024

Related U.S. Application Data
(63) Continuation of application No. PCT/KR2022/020693, filed on Dec. 19, 2022.

(30) Foreign Application Priority Data
Dec. 31, 2021 (KR) 10-2021-0194060
Jan. 17, 2022 (KR) 10-2022-0006486

(51) Int. Cl. H02J 50/80; H02J 50/12

(52) U.S. Cl. CPC H02J 50/80; H02J 50/12

(57) ABSTRACT

An electronic device is provided. The electronic device includes a battery, a multi-coil circuitry including a first coil and a second coil, magnetic field control circuitry electrically connected to the multi-coil circuitry, a power management module electrically connected to the battery and the magnetic field control circuitry, memory storing one or more computer programs, and one or more processors communicatively coupled to the battery, the multi-coil circuitry, the magnetic field control circuitry, the power management module, and the memory, wherein the one or more computer programs include computer-executable instructions that, when executed by the one or more processors individually or collectively, cause the electronic device to detect an external electronic device by performing a ping operation using the first coil, identify a type of the detected external electronic device, when the external electronic device is an external electronic device of a first type, wirelessly transmit power to the external electronic device by using the first coil and the second coil, when the external electronic device is an external electronic device of a second-type, wirelessly transmit power through the first coil, identify a magnitude of transmission power transmitted through the first coil, select the first coil or select the first coil and the second coil based on comparing the magnitude of the transmission power with a designated power threshold, and wirelessly transmit power to the external electronic device using the first coil or wirelessly transmit power to the external electronic device using the first coil and second coil.

### CROSS-REFERENCE TO RELATED APPLICATION(S)

This application is a continuation application, claiming priority under § 365 (c), of an International application No. PCT/KR2022/020693, filed on Dec. 19, 2022, which is based on and claims the benefit of a Korean patent application number 10-2021-0194060, filed on Dec. 31, 2021, in the Korean Intellectual Property Office, and of a Korean patent application number 10-2022-0006486, filed on Jan. 17, 2022, in the Korean Intellectual Property Office, the disclosure of each of which is incorporated by reference herein in its entirety.

### BACKGROUND

### 1. Field

The disclosure relates to an electronic device and a wireless power transmission method using multiple coils in an electronic device.

### 2. Description of Related Art

Since developed, wireless power transfer has been adopted for wireless or contactless charging many electronic devices. Wireless power transfer is technology that converts electrical energy into electromagnetic waves having a frequency and wirelessly transfers energy to a load without a transmission line. Wireless power transfer may be technology to wirelessly transfer power from a power transmission device to a power reception device without wired connection and charging the battery of the power reception device. Wireless power transfer may include a magnetic induction scheme, a magnetic resonance scheme, or other various wireless power transfer schemes.

For example, the magnetic induction scheme transfers power using the magnetic field induced in a coil, and in this scheme, the magnetic field generated from the current flowing through a transmission coil is used to allow an induced current to flow through a reception coil and supply energy to the load. Representative standards for the magnetic induction scheme include wireless power consortium (WPC) and power matters alliance (PMA). As power transmission, designated frequencies may be used, e.g., 110 to 205 kilohertz (kHz) for WPC and 227 to 357 kHz and 118 to 153 kHz for PMA.

The above information is presented as background information only to assist with an understanding of the disclosure. No determination has been made, and no assertion is made, as to whether any of the above might be applicable as prior art with regard to the disclosure.

### SUMMARY

An electronic device (e.g., a wireless power transmission device) may perform wireless power transmission/reception with an external electronic device (e.g., a wireless power reception device) through electrical induction using a wireless power transmission technology. The electronic device may detect (or recognize) the external electronic device for wireless power transmission in a standby mode (standby state or sleep mode) and start wireless power transmission when recognizing the external electronic device.

The electronic device may succeed or fail in recognition of the external electronic device according to the physical distance to the external electronic device and/or an alignment state. For example, the electronic device may have difficulty in recognizing the external electronic device when the distance to the external electronic device is a designated distance or more or the coil of the electronic device is misaligned with the coil of the external electronic device. Even when the electronic device succeeds in recognizing the external electronic device and thus performs wireless power transmission, the power transmission efficiency may be low depending on the distance to the external electronic device and the degree of alignment.

Aspects of the disclosure are to address at least the above-mentioned problems and/or disadvantages and to provide at least the advantages described below. Accordingly, an aspect of the disclosure is to provide an electronic device and a wireless power transmission method based on multiple coils in an electronic device, which may increase the recognition success rate of an external electronic device and wireless power transmission efficiency by recognizing an external electronic device using a coil allowing an electronic device having multiple coils to be more easily aligned with the external electronic device when recognizing the external electronic device among the multiple coils and performing wireless power transmission using a coil providing higher wireless power transmission efficiency after recognizing the external electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a battery, multi-coil circuitry including a first coil and a second coil surrounding an outer diameter of the first coil, magnetic field control circuitry electrically connected to the multi-coil circuitry, a power management module electrically connected to the battery and the magnetic field control circuitry, memory storing one or more computer programs, and one or more processors communicatively coupled to the battery, the multi-coil circuitry, the magnetic field control circuitry, the power management module, and the memory, wherein the one or more computer programs include computer-executable instructions that, when executed by the one or more processors individually or collectively, cause the electronic device to detect an external electronic device by performing a ping operation using the first coil and identify a type of the detected external electronic device, when the external electronic device is an external electronic device of a first type, wirelessly transmit power to the external electronic device using the first coil and the second coil, when the external electronic device is an external electronic device of a second type, wirelessly transmit power through the first coil, identify a magnitude of transmission power transmitted through the first coil, select the first coil or select the first coil and the second coil based on comparing the magnitude of the transmission power with a designated power threshold, and wirelessly transmit power to the external electronic device using the first coil or wirelessly transmit power to the external electronic device using the first coil and second coil.

In accordance with another aspect of the disclosure, a method for transmitting wireless power based on multi-coil in an electronic device is provided. The method includes detecting an external electronic device by performing a ping operation using a first coil of the first coil and a second coil, identifying a type of the detected external electronic device, when the external electronic device is an external electronic device of a first type, wirelessly transmitting power to the external electronic device using the first coil and the second coil, and when the external electronic device is an external electronic device of a second type, wirelessly transmitting power through the first coil, identifying a magnitude of transmission power transmitted through the first coil, selecting the first coil or selecting the first coil and the second coil based on comparing the magnitude of the transmission power with a designated power threshold, and wirelessly transmitting power to the external electronic device using the first coil or wirelessly transmitting power to the external electronic device using the first coil and second coil.

In accordance with another aspect of the disclosure, one or more non-transitory computer-readable storage media storing computer-executable instructions that, when executed by one or more processors individually or collectively included in an electronic device, cause the electronic device to perform operations are provided. The operations include detecting an external electronic device by performing a ping operation using a first coil of the first coil and a second coil, identifying a type of the detected external electronic device, when the external electronic device is an external electronic device of a first type, wirelessly transmitting power to the external electronic device using the first coil and the second coil, and when the external electronic device is an external electronic device of a second type, wirelessly transmitting power through the first coil, identifying a magnitude of transmission power transmitted through the first coil, selecting the first coil or selecting the first coil and the second coil based on comparing the magnitude of the transmission power with a designated power threshold, and wirelessly transmitting power to the external electronic device using the first coil or wirelessly transmitting power to the external electronic device using the first coil and second coil.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an electronic device including a multi-coil circuit according to an embodiment of the disclosure;

FIG. 3 is a view illustrating a multi-coil circuit according to an embodiment of the disclosure;

FIG. 4A is a view illustrating a case in which a switch of a multi-coil circuit is in a switch-on state according to an embodiment of the disclosure;

FIG. 4B is a view illustrating a case in which a switch of a multi-coil circuit is in a switch-off state according to an embodiment of the disclosure;

FIG. 5 is a flowchart illustrating a multi-coil-based wireless power transmission method in an electronic device according to an embodiment of the disclosure;

FIG. 6 is a flowchart illustrating a switch control operation when an electronic device transmits wireless power using multiple coils according to an embodiment of the disclosure;

FIG. 7A is a view illustrating an efficiency characteristic when an electronic device performs wireless power transmission using a first coil and a second coil according to an embodiment of the disclosure;

FIG. 7B is a view illustrating an efficiency characteristic when an electronic device performs wireless power transmission by switching on or off depending on a magnitude of transmission power to an external electronic device according to an embodiment of the disclosure; and

FIG. 8 is a flowchart illustrating an alignment notification operation based on identifying whether an electronic device and an external electronic device are aligned according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

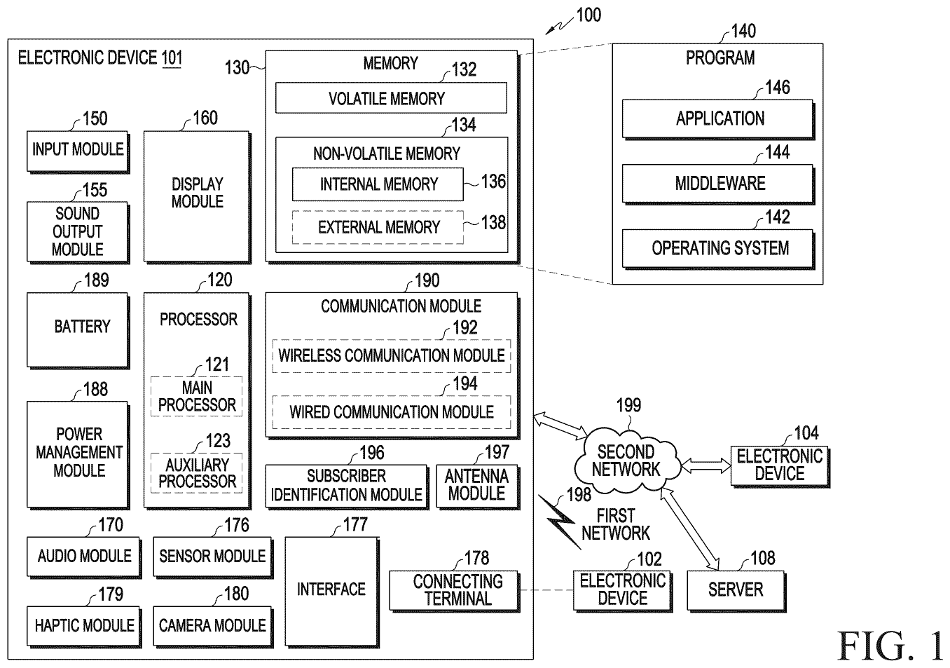

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one (e.g., the connecting terminal 178) of the components may be omitted from the electronic device 101, or one or more other components may be added in the electronic device 101. According to an embodiment of the disclosure, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor configured to detect a touch, or a pressure sensor configured to measure the intensity of a force generated by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 gigabits per second (Gbps) or more) for implementing eMBB, loss coverage (e.g., 164 dB or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device). According to an embodiment of the disclosure, the antenna module 197 may include one antenna including a radiator formed of a conductor or conductive pattern formed on a substrate (e.g., a printed circuit board (PCB)). According to an embodiment of the disclosure, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment of the disclosure, other parts (e.g., radio frequency integrated circuit (RFIC)) than the radiator may be further formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment of the disclosure, all or some of operations to be executed at the electronic device 101 may be executed at one or more of the external electronic devices 102 and 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example.

The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or health-care) based on 5G communication technology or IoT-related technology.

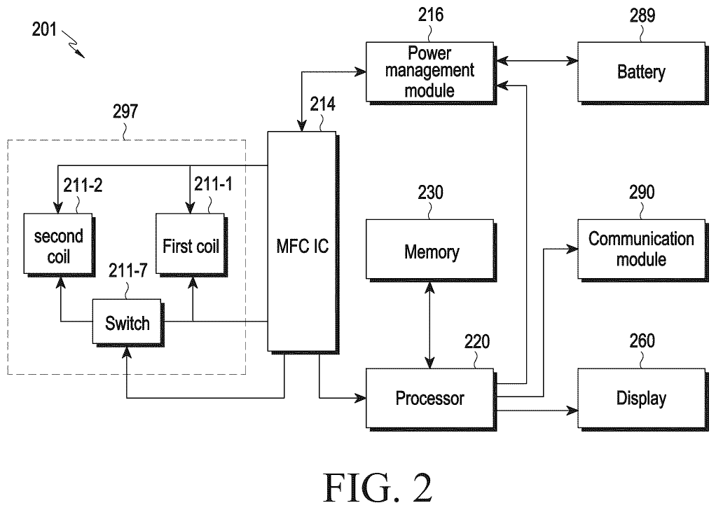

FIG. 2 is a block diagram illustrating an electronic device including a multi-coil circuit according to an embodiment of the disclosure.

Referring to FIG. 2, an electronic device 201 (or a wireless power transmission device) (e.g., the electronic device 101 of FIG. 1) may include all or some of a multi-coil circuit 297 (e.g., the antenna module 197 of FIG. 1), a magnetic field control circuitry (magnetic field controller integrated circuit (MFC IC)) 214, a power management module (power management integrated circuit (PMIC chip)) 216, a processor 220 (e.g., the processor 120 of FIG. 1), memory 230 (e.g., the memory 130 of FIG. 1), a battery 289 (e.g., the battery 189 of FIG. 1), a communication module 290 (e.g., the communication module 190 of FIG. 1), and a display 260 (e.g., the display module 160 of FIG. 1).

According to an embodiment of the disclosure, the multi-coil circuit 297 may be a parallel dual coil and may include a first coil 211-1, a second coil 211-2, and a switch 211-7. The multi-coil circuit 297 may further include an additional coil in addition to the first coil 211-1 and the second coil 211-2. According to an embodiment of the disclosure, the multi-coil circuit 297 may be an integrated package of the first coil 211-1, the second coil 211-2, and the switch 211-7. According to an embodiment of the disclosure, the first coil 211-1 and the second coil 211-2 may be coils for wireless power transmission/reception (e.g., near field magnetic induction (NFMI)). According to an embodiment of the disclosure, the first coil 211-1 may be included inside (Coil_IN) the multi-coil circuit 297, and the second coil 211-2 may be included outside (Coil_OUT) the first coil 211-1. According to an embodiment of the disclosure, the first coil 211-1 and the second coil 211-2 may have a length (or number of turns) used to wirelessly transmit power. According to an embodiment of the disclosure, the first coil 211-1 may have a length (or number of turns) used to wirelessly transmit first power using the first coil 211-1. According to an embodiment of the disclosure, the first coil 211-1 and the second coil 211-2 may have a length (or number of turns) used to wirelessly transmit second power using the first coil 211-1 and the second coil 211-2 connected in parallel with each other. According to an embodiment of the disclosure, the switch 211-7 may have an end connected to the first coil 211-1 and the MFC IC 214 and another end connected to the second coil 211-2. According to an embodiment of the disclosure, the first switch 211-7 may perform a switch on/off operation under the control of the processor 220 (e.g., the processor 120 of FIG. 1). According to an embodiment of the disclosure, when the switch 211-7 is switched on, the first coil 211-1 and the second coil 211-2 may be connected in parallel, and the first coil 211-1 and the second coil 211-2 connected in parallel may be connected to the MFC IC 214. According to an embodiment of the disclosure, when the switch 211-7 is switched off, the first coil 211-1 and the second coil 211-2 are not connected, and the first coil 211-1 may be connected to the MFC IC 214.

According to an embodiment of the disclosure, the MFC IC 214 may be connected to the first coil 211-1 or connected to the first coil 211-1 and the second coil 211-2, which are connected in parallel, based on the switch-on or switch-off operation of the switch 211-7. According to an embodiment of the disclosure, the MFC IC 214 may perform a wireless power reception operation or wireless power transmission operation using the first coil 211-1 and a second coil 211-2 connected in parallel, of the multi-coil circuit 297. According to an embodiment of the disclosure, the MFC IC 214 may include a wireless power reception circuit (not shown) for wireless power reception and a wireless power transmission circuit (not shown) for wireless power transmission. For example, upon receiving wireless power, the wireless power reception circuit may perform power processing, such as rectifying the alternating current (AC) waveform of power received through the first coil 211-1 or the first coil 211-1 and the second coil 211-2 connected in parallel into a DC waveform, converting the voltage, or regulating the power and transfer the same to the power management module 216. For example, upon transmitting wireless power, the wireless power transmission circuit may receive power from the power management module 216, generate an AC waveform for power transmission, and generate a magnetic field through the first coil 211-1 or the first coil 211-1 and the second coil 211-2 connected in parallel based on the generated AC waveform to allow wireless power to be transmitted through the magnetic field. According to an embodiment of the disclosure, upon wireless power transmission, the MFC IC 214 may perform operating frequency adjustment and duty control based on the power control packet (e.g., control error packet (CEP)) received from an external electronic device (e.g., wireless power reception device). According to an embodiment of the disclosure, the MFC IC 214 may transfer the operating frequency to the processor 220 at designated time intervals or regularly during wireless power transmission. According to an embodiment of the disclosure, the MFC IC 214 may transfer a switch-on or switch-off control signal to the switch 211-7, in a designated scheme (e.g., a general-purpose input/output (GPIO) scheme), based on the switch-on or switch-off control of the processor 220.

According to an embodiment of the disclosure, the power management module 216 may be connected between the MFC IC 214 and the battery 289. According to an embodiment of the disclosure, the power management module 216 may charge the battery 289 with the power received using the multi-coil circuit 212 and the MFC IC 214 and output the power from the battery 289 to the outside through the MFC IC 214 and the multi-coil circuit 212. For example, the MFC IC 214 may allow a magnetic field to be formed at the first coil 211-1 or the first coil 211-1 and a second coil circuit (i.e., the multi-coil circuit 297) of the multi-coil circuit 297 using the power received through the power management module 216, so that the power is wirelessly transmitted to the external electronic device. For example, it is possible to allow the power from the battery 989 to be wirelessly shared with the external electronic device. According to an embodiment of the disclosure, the external electronic device may be one of various types of external electronic devices. For example, various types of external electronic devices may include an accessory device (e.g., a smart watch, a wireless headset, or a wireless earphone) capable of interworking with the electronic device 201 (e.g., a smartphone). According to an embodiment of the disclosure, the power management module 216 may include an MFC IC 214 to be monolithically implemented.

According to an embodiment of the disclosure, the processor 220 may perform a ping (ping phase) operation, an authentication (identification & configuration) operation, and/or a power transmission (power transfer phase) operation to provide power for wireless power transmission. For example, the ping operation may be an operation for outputting a ping signal and detecting an external electronic device (e.g., the external electronic device 102 of FIG. 1) to receive wireless power based on the ping signal. The authentication operation may be an operation for receiving identification information and/or authentication information from the detected external electronic device 102 and identify and/or authenticate the external electronic device 102. The power transmission operation may be an operation for wirelessly transmitting power to the identified and/or authenticated external electronic device 102.

According to an embodiment of the disclosure, the processor 220 may control to periodically output a ping signal during the ping operation based on a power transmission request. The processor 220 may sense or detect an external electronic device based on detection of a response (e.g., signal strength packet (SSP)) corresponding to the ping signal from the external electronic device (e.g., the external electronic device 102 of FIG. 1).

According to an embodiment of the disclosure, the processor 220 may output a ping signal through the first coil 211-1 during the ping operation, and may detect or sense the external electronic device 102 as a response corresponding to the ping signal is detected. For example, the processor 220 may output the ping signal through the first coil 211-1 (e.g., some coils in the center among the multiple coils), thereby reducing the area where the ping signal is recognizable by the external electronic device 102 while making the area closer to the center than when outputting the ping signal through the first coil 211-1 and the second coil 211-2 (e.g., all of the multiple coils). Accordingly, the processor 220 may increase the recognizability of an external electronic device closer to the multiple coils (or the center of the multiple coils) than an external electronic device far from the multiple coils (or the center of the multiple coils).

According to an embodiment of the disclosure, the processor 220 may perform the authentication operation in the state in which the external electronic device 102 is detected. The processor 220 may identify the type of the external electronic device 102 in the authentication operation. For example, the processor 220 may identify whether the external electronic device is a first-type external electronic device that receives wireless power using a coil having a first coil size or a second-type external electronic device that receives wireless power using a coil having a second size. For example, the first-type external electronic device may be an external electronic device (e.g., a first external electronic device or a smart phone) having a coil having a first size, and the second-type external electronic device may be an external electronic device (e.g., a second external electronic device or an accessory device or a smart watch or a wireless earphone) having a coil having a size smaller than the first size. For example, the first size may be similar to or the same as the sum of the sizes of the first coil 211-1 and the second coil 211-2 within a designated range. For example, the first size may be the same as the sizes of the first coil 211-1 and the second coil 211-2, or may be a designated size (e.g., several mm) larger or smaller than the sizes of the first coil 211-1 and the second coil 211-2. For example, the second size may be similar to or the same as the size of the first coil 211-1 within a designated range. For example, the first size may be equal to the size of the first coil 211-1, or may be a designated size (e.g., several mm) larger or smaller than the size of the first coil 211-1. For example, the processor 220 may identify the type of the external electronic device 102 using the external electronic device ID and/or information associated with the size of the coil (or reception coil) of the external electronic device, or may identify the type of the external electronic device 102 using a Q factor. The processor 220 may identify the type of the external electronic device 102 in other ways.

According to an embodiment of the disclosure, when the type of the external electronic device 102 is the first type, the processor 220 may control to wirelessly transmit power using the first coil 211-1 and the second coil 211-2. For example, when the external electronic device 102 is a first-type electronic device including a coil having a size similar within a designated range or identical to the sum of the sizes of the first coil 211-1 and the second coil 211-2, the processor 220 may identify (or select) the first coil 211-1 and the second coil 211-2 as coils to transmit wireless power and control to wirelessly transmit power using the first coil 211-1 and the second coil 211-2.

According to an embodiment of the disclosure, when the type of the external electronic device 102 is the second type, the processor 220 may wirelessly transmit power using the first coil 211-1, and may identify the magnitude of the transmission power when transmitting wireless power using the first coil 211-1. For example, the processor 220 may adjust the magnitude of the transmission power by adjusting the operating frequency and the operating voltage in a designated frequency range (fLkHz to fHkHz) (e.g., 100 kHz to 196 kHz, 110 kHz to 148 kHz, or other operating frequency ranges) and in a designated operating voltage range (e.g., 5 v to 9 v or other operating voltage ranges) according to a request for increasing or decreasing transmission power from the external electronic device during wireless power transmission. For example, when decreasing the operating frequency in the designated frequency range and increasing the operating voltage in the designated operating voltage range, the processor 220 may increase the magnitude of transmission power and, when increasing the operating frequency in the designated frequency range and decreasing the operating voltage in the designated operating voltage range, decrease the magnitude of the transmission power. For example, the external electronic device 102 does not receive as much power as desired due to a state of being misaligned with the electronic device 201, the external electronic device 102 may transmit a transmission power increase request signal to the electronic device 201, and the processor 220 may increase the magnitude of transmission power by controlling to decrease the operating frequency in the designated frequency range and increase the operating voltage in the designated operating voltage range according to the transmission power increase request signal from the external electronic device 102.

The processor 220 according to an embodiment may compare the magnitude of the transmission power identified during wireless power transmission with a designated power threshold using the first coil 211-1. For example, the designated power threshold may be a predetermined power threshold to determine whether the electronic device 201 and the external electronic device of the second type are misaligned (by experiment or calculation) when wireless power is transmitted from the electronic device 201 to the external electronic device of the second type. For example, when the electronic device 201 and the second-type external electronic device are misaligned, the second-type external electronic device may request to increase transmission power, and the electronic device 201 may increase the transmission power to a value larger than the designated power threshold. For example, the processor 220 may determine (or identify) that the electronic device 201 and the second-type external electronic device are misaligned when the magnitude of the identified transmission power is larger than the designated power threshold when transmitting wireless power using the first coil 211-1. For example, if the magnitude of transmission power identified during wireless power transmission using the first coil 211-1 is the designated power threshold or less, the processor 220 may determine (or identify) that the electronic device 201 and the second-type external electronic device are not misaligned. According to an embodiment of the disclosure, the processor 220 may adjust the operating frequency and/or operating voltage to increase the magnitude of the transmission power and may thus compare the magnitude of the operating frequency and/or the magnitude of the operating voltage with the designated frequency threshold and/or the designated voltage threshold, rather than comparing the magnitude of transmission power with the designated power threshold, when transmitting wireless power from the electronic device 201 to the second-type external electronic device. For example, each of the designated voltage threshold and/or the designated frequency threshold may be a predetermined value to determine whether the electronic device 201 and the second-type external electronic device are misaligned (by experiment or calculation) when transmitting wireless power from the electronic device 201 to the second-type external electronic device. For example, when the electronic device 201 and the second-type external electronic device are misaligned, the second-type external electronic device may request to increase transmission power, and the processor 220 may decrease the operating frequency, or increase the operating voltage, or decrease the operating frequency while increasing the operating voltage so as to increase transmission power. For example, the processor 220 may determine (or identify) that the electronic device 201 and the second-type external electronic device are misaligned when the operating frequency identified during wireless power transmission using the first coil 211-1 is lower than the designated frequency threshold, or the operating voltage identified during wireless power transmission using the first coil 211-1 is higher than the designated voltage threshold, or the operating frequency identified during wireless power transmission using the first coil 211-1 is lower than the designated frequency threshold and the operating voltage is higher than the designated operating voltage threshold. For example, the processor 220 may determine (or identify) that the electronic device 201 and the second-type external electronic device are not misaligned when the operating frequency identified during wireless power transmission using the first coil 211-1 is the designated frequency threshold or more, or the operating voltage identified during wireless power transmission using the first coil 211-1 is the designated voltage threshold or less, or the operating frequency identified during wireless power transmission using the first coil 211-1 is the designated frequency threshold or more and the operating voltage is the designated operating voltage threshold or less.

The processor 220 according to an embodiment may select the first coil 211-1, or the first coil 211-1 and the second coil 211-2, as a coil for wireless power transmission to the second-type external electronic device based on a result of comparison between the magnitude of the transmission power identified during wireless power transmission using the first coil 211-1 and the designated power threshold. For example, since the processor 220 may determine (or identify) that the electronic device 201 and the second-type external electronic device are misaligned if the magnitude of the transmission power identified during wireless power transmission using the first coil 211-1 is larger than the designated power threshold, the processor 220 may select the first coil 211-1 and the second coil 211-2 as coils for wireless power transmission so that the wireless charging area is relatively increased. For example, since the processor 220 may determine (or identify) that the electronic device 201 and the second-type external electronic device are not misaligned if the magnitude of the transmission power identified during wireless power transmission using the first coil 211-1 is the designated power threshold or less, the processor 220 may select the first coil 211-1 as a coil for wireless power transmission so that the wireless charging area is maintained.

According to an embodiment of the disclosure, when the processor 220 compares the magnitude of the operating frequency and/or the magnitude of the operating voltage with the designated frequency threshold and/or designated voltage threshold rather than comparing the magnitude of transmission power with the designated power threshold during wireless power transmission to the second-type external electronic device, the processor 220 may select the first coil 211-1, or the first coil 211-1 and the second coil 211-2, as the coil for wireless power transmission based on the comparison result. For example, since the processor 220 may determine (or identify) that the electronic device 201 and the second-type external electronic device are misaligned when the operating frequency identified during wireless power transmission using the first coil 211-1 is lower than the designated frequency threshold, or the operating voltage identified during wireless power transmission using the first coil 211-1 is higher than the designated voltage threshold, or the operating frequency identified during wireless power transmission using the first coil 211-1 is lower than the designated frequency threshold and the operating voltage is higher than the designated operating voltage threshold, the processor 220 may select the first coil 211-1 and the second coil 211-2 as the coil for wireless power transmission so that the wireless charging area is relatively increased. For example, since the processor 220 may determine (or identify) that the electronic device 201 and the second-type external electronic device are not misaligned when the operating frequency identified during wireless power transmission using the first coil 211-1 is the designated frequency threshold or more, or the operating voltage identified during wireless power transmission using the first coil 211-1 is the designated voltage threshold or less, or the operating frequency identified during wireless power transmission using the first coil 211-1 is the designated frequency threshold or more and the operating voltage is the designated operating voltage threshold or less, the processor 220 may select the first coil 211-1 as the coil for wireless power transmission so that the wireless charging area is maintained. The processor 220 according to an embodiment may perform wireless power transmission using the selected first coil 211-1 or perform wireless power transmission using the selected first coil 211-1 and second coil 211-2.

According to an embodiment of the disclosure, the processor 220 may perform the operation of identifying the alignment state after or during wireless power transmission to the external electronic device 102 (first-type or second-type external electronic device). According to an embodiment of the disclosure, the processor 220 may perform the operation of identifying the alignment state according to a designated condition or a request for identifying the alignment state from the external electronic device 102 during wireless power transmission to the external electronic device 102. According to an embodiment of the disclosure, the processor 220 may transmit alignment state identify start identification information (e.g., an align identify start indicator) for identifying the alignment state to the external electronic device 102. For example, the electronic device 201 and the external electronic device 102 may use packets, procedures, and/or timings pre-agreed therebetween. According to an embodiment of the disclosure, the processor 220 may turn on the switch 211-7 to transmit first power through the first coil 211-1 and the second coil 211-2 during a designated time period (e.g., during a first time period agreed on with the external electronic device) after the alignment state identify start identification information and then turn off the switch 211-7 to transmit second power through the first coil 211-1 during a next designated time period (e.g., during a second time period agreed on with the external electronic device). According to an embodiment of the disclosure, the processor 220 may transmit the first power through the first coil 211-1 and the second coil 211-2 after transmitting the second power through the first coil 211-1.

The external electronic device 102 according to an embodiment may identify each of the magnitude of the power (e.g., first reception power) received during the first time period and the magnitude of the power (e.g., second reception power) received during the second time period.

The external electronic device 102 according to an embodiment may identify (or determine) whether it is aligned with the electronic device 201 based on the magnitude of the first reception power and the magnitude of the second reception power. For example, when the magnitude of the first reception power or the magnitude of the second reception power is equal to or less than (or less than) a predetermined threshold lower limit power amount, the external electronic device 102 may identify that the electronic device 201 and the external electronic device are misaligned. For example, when the external electronic device 102 is a second-type external electronic device, the power received by the electronic device 201 in a state in which the electronic device 201 is in a switch-on state, and the electronic device 201 and the external electronic device are aligned may be included in a first power quantity range (e.g., about 0.74 w). For example, when the external electronic device 102 is a second-type external electronic device, the power received by the electronic device 201 in a state in which the electronic device 201 is in a switch-off state, and the electronic device 201 and the external electronic device are aligned may be included in a second power quantity range larger, within a slight error range, than the first power quantity range. For example, when the external electronic device 102 is a second-type external electronic device, the power received by the electronic device 201 in a state in which the electronic device 201 is in a switch-on state, and the electronic device 201 and the external electronic device 102 are misaligned may be included in a third power quantity range larger, within a slight error range, than the first power quantity range. For example, when the external electronic device is a second-type external electronic device, the power received by the external electronic device 102 in a state in which the electronic device 201 is in a switch-off state, and the electronic device 201 and the external electronic device are misaligned may be included in equal to or less than a fourth power amount range smaller than the first power amount range to fall outside an error range. For example, the fourth power amount range may include a threshold lower limit power amount range or a threshold lower limit power amount.

For example, when the magnitude of the first reception power or the magnitude of the second reception power is not equal to or less than (or less than) a predetermined threshold lower limit power amount, the external electronic device 102 may identify that the electronic device 201 and the external electronic device 102 are not misaligned. The external electronic device 102 according to an embodiment may display, on the display, information indicating whether the external electronic device 102 is aligned or misaligned with the electronic device 201 or output, through the speaker, a sound corresponding to the information indicating whether the external electronic device 102 and the electronic device 201 are aligned or misaligned, based on identifying whether the electronic device 201 and the external electronic device are aligned.

According to an embodiment of the disclosure, the memory 230 (e.g., the memory 130 of FIG. 1) may store various control data used by at least one component (e.g., the processor 220 or the MFC IC 214) of the electronic device 201. According to an embodiment of the disclosure, the memory 230 may store instructions to perform the operation of the processor 220 of the electronic device 201. According to various embodiments of the disclosure, the memory 230 may be implemented in various types, such as read only memory (ROM), random access memory (RAM), or flash memory, but not limited in type thereto.

According to an embodiment of the disclosure, the communication module 290 may communicate with an external electronic device and/or another external electronic device or server and may obtain external electronic device identification information or external electronic device coil size-associated information through communication.

According to an embodiment of the disclosure, the display 260 may display data or a screen required for a wireless power transmission operation. For example, the display 260 may display data or a screen for obtaining information associated with the size of the coil of the external electronic device.

According to an embodiment of the disclosure, the electronic device 201 may further include an input module (e.g., a touch input module, a key input module, or a user interface module) and may receive, from the user, information associated with the type of the external electronic device through the input module.

In the above-described description, the operations of the electronic device (e.g., the electronic device 101 of FIG. 1 or the electronic device 201 of FIG. 2) and the external electronic device 102 are separately described, but the electronic device (e.g., the electronic device 101 of FIG. 1 or the electronic device 201 of FIG. 2) may perform the operations of the external electronic device 102. For example, the electronic device 201 (or the processor 220 of the electronic device 201) may perform the operations of the electronic device 201 during wireless power transmission and perform the operations of the external electronic device 102 during wireless power reception.

According to various embodiments of the disclosure, an electronic device (e.g., the electronic device 101 of FIG. 1 or the electronic device 201 of FIG. 2) may comprise a battery (e.g., the battery 189 of FIG. 1 or the battery 289 of FIG. 2), multi-coil circuitry (e.g., the multi-coil circuit 297 of FIG. 2) including a first coil (the first coil 211-1 of FIG. 2) and a second coil (e.g., the second coil 211-2 of FIG. 2), a magnetic field control circuitry (e.g., the magnetic field control circuitry 214 of FIG. 2) electrically connected to the multi-coil circuitry, a power management module (e.g., the power management module 188 of FIG. 1 or the power management module 216 of FIG. 2) electrically connected to the battery and the magnetic field control circuitry, and a processor (e.g., the processor 120 of FIG. 1 or the processor 220 of FIG. 2) electrically connected to the multi-coil circuitry, the magnetic field control circuitry, and the power management module. The processor may be configured to detect an external electronic device by performing a ping operation using the first coil and identify a type of the detected external electronic device, when the external electronic device is an external electronic device of a first type, wirelessly transmit power to the external electronic device using the first coil and the second coil, and when the external electronic device is an external electronic device of a second type, wirelessly transmit power through the first coil, identify a magnitude of transmission power transmitted through the first coil, select the first coil or select the first coil and the second coil based on comparing the magnitude of the transmission power with a designated power threshold, and wirelessly transmit power to the external electronic device using the first coil or wirelessly transmit power to the external electronic device using the first coil and second coil.

According to various embodiments of the disclosure, the processor may be further configured to, when the external electronic device is the external electronic device of the second type, wirelessly transmit the power through the first coil to identify an operating frequency associated with the magnitude of the transmission power transmitted through the first coil and select the first coil or select the first coil and the second coil based on comparing a magnitude of the operating frequency with a designated operating frequency.

According to various embodiments of the disclosure, the processor may be further configured to, when the external electronic device is the external electronic device of the second type, wirelessly transmit the power through the first coil, identify an operating voltage associated with the magnitude of the transmission power transmitted through the first coil and select the first coil or select the first coil and the second coil based on comparing a magnitude of the operating voltage with a designated operating voltage.

According to various embodiments of the disclosure, the processor may be further configured to, when the external electronic device is the external electronic device of the second type, wirelessly transmit the power through the first coil, identify an operating voltage and an operating frequency associated with the magnitude of the transmission power transmitted through the first coil and select the first coil or select the first coil and the second coil based on comparing a magnitude of the operating voltage with a magnitude of the operating frequency and a designated operating voltage and a designated operating frequency.

According to various embodiments of the disclosure, the external electronic device of the first type may include a coil of a first size, and the external electronic device of the second type includes a coil of a second size smaller than the first size.

According to various embodiments of the disclosure, the first coil may be a circular coil, and the second coil may be a circular coil surrounding an outside of the first coil.

According to various embodiments of the disclosure, one end of the first coil and the other end of the first coil may be connected to the magnetic field control circuitry, and the one end of the first coil may be connected to the second coil. One end of the second coil may be connected the one end of the first coil, and the other end of the second coil may be connected to a switch. One end of the switch may be connected to the second end of the second coil, and the other end of the switch may be connected to the magnetic field control circuitry.

According to various embodiments of the disclosure, the processor may control the switch to switch off so that the first coil and second coil connected in parallel are connected to the magnetic field control circuitry and control the switch to switch on so that the first coil is connected to the magnetic field control circuitry.

According to various embodiments of the disclosure, the processor may be further configured to, based on receiving request information to identify an alignment state between the electronic device and the external electronic device from the external electronic device during wirelessly transmitting power transmission to the external electronic device, transmit response information in response to the request information to the external electronic device, control the switch to switch on during a first time period after transmitting the response information to the external electronic device to wirelessly transmit power through the first coil and the second coil, and control the switch to switch off during a second time period after the first time period to wirelessly transmit power through the first coil.

According to various embodiments of the disclosure, the processor may be further configured to based on receiving response information in response to request information to identify an alignment state between the electronic device and another external electronic device from the another external electronic device during wirelessly transmitting power to the another external electronic device, identify a magnitude of first power received during a first time period and a magnitude of second power received during a second time period after the first time period and identify whether the electronic device is in a state of being aligned or misaligned with the another external electronic device based on comparing the magnitude of the first power or the magnitude of the second power with a designated power.

According to various embodiments of the disclosure, the electronic device may further comprise a display. The processor may be further configured to, when identifying that the electronic device is in the state of being misaligned with the another external electronic device, display, on the display, information indicating the misaligned state.

According to various embodiments of the disclosure, the electronic device may further comprise a speaker. The processor may be further configured to, when identifying that the electronic device is in the state of being misaligned with the another external electronic device, output, through the speaker, a sound corresponding to information indicating the misaligned state.

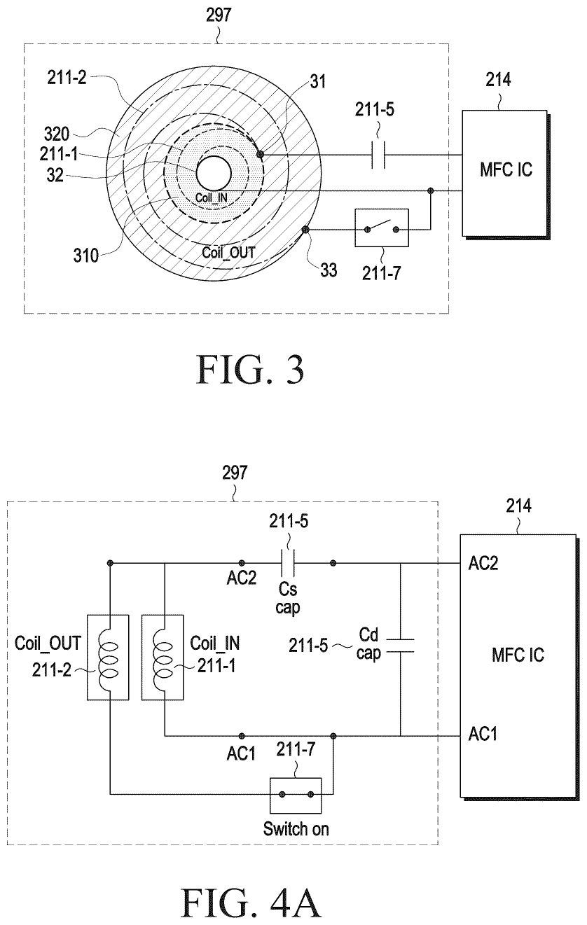

FIG. 3 is a view illustrating a multi-coil circuit according to an embodiment of the disclosure.

Referring to FIG. 3, according to an embodiment of the disclosure, in a multi-coil circuit 297, a first coil (e.g., the first coil 211-1 of FIG. 2) may be disposed in a Coil_IN area 310, and a second coil (e.g., the second coil 211-2 of FIG. 2) may be disposed in a Coil_OUT area 320. For example, the first coil 211-1 may be a coil (or circular coil) disposed in the center of the multi-coil circuit 297, and the second coil 211-2 may be a coil surrounding the first coil 211-1. The Coil_IN area 310 and the Coil_OUT area 320 of the multi-coil circuit 297 may overlap. According to an embodiment of the disclosure, the multi-coil circuit 297 may be branched into the first coil 211-1 and the second coil 211-2 at a first point 31 which is a boundary point (e.g., the outer diameter of the first coil 211-1 or the inner diameter of the second coil 211-2) between the Coil_IN area 310 and the Coil_OUT area 320.

According to an embodiment of the disclosure, the first coil 211-1 may be wound to have a designated number of turns from the first point 31 to a second point 32 (e.g., the innermost point of the Coil_IN area 310) inside the Coil_IN area 310, and the second point 32 may be connected to the MFC IC 214. According to an embodiment of the disclosure, the second coil 211-2 may be wound to have a designated number of turns from the first point 31 to a third point 33 (e.g., the outermost point of the Coil_OUT area 320) outside the Coil_OUT area 320, and the third point 33 may be connected to the switch 211-7.

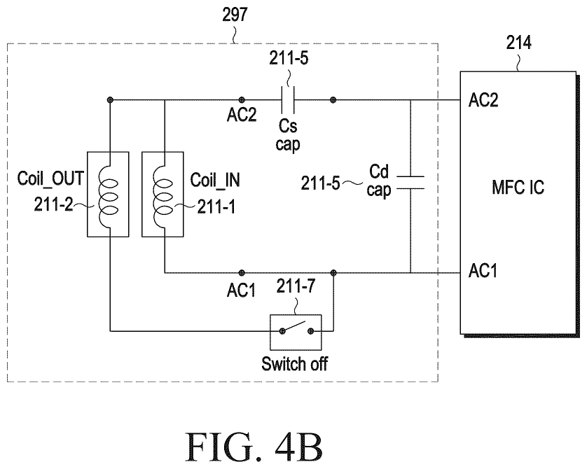

FIG. 4A is a view illustrating a case in which a switch of a multi-coil circuit is in a switch-on state according to an embodiment of the disclosure. and FIG. 4B is a view illustrating a case in which a switch of a multi-coil circuit is in a switch-off state according to an embodiment of the disclosure.

Referring to FIGS. 4A and 4B, according to an embodiment of the disclosure, the multi-coil circuit 297 may include a first coil 211-1, a second coil 211-2, a capacitance 211-5, and a switch 211-7. According to an embodiment of the disclosure, the first coil 211-1 and the second coil 211-2 may be coils for wireless power transmission/reception (e.g., NFMI).

According to an embodiment of the disclosure, the first coil 211-1 may be the inner coil Coil_IN, and the second coil 211-2 may be disposed as the outer coil Coil_OUT of the first coil 211-1.

According to an embodiment of the disclosure, two opposite ends AC1 and AC2 of the first coil 211-1 may be connected to the MFC IC 214, and one end AC2 of the two opposite ends AC1 and AC2 of the first coil 211-1 may be connected to the second coil 211-2.

According to an embodiment of the disclosure, one end of the second coil 211-2 may be connected to the first coil 211-1, and the other end may be connected to the switch 211-7.

According to an embodiment of the disclosure, the capacitance (Cs cap, Cd cap) 211-5 may have a capacitance value required for the multi-coil circuit 297 to maintain a designated inductance and resistance when the first power is wirelessly transmitted to the external electronic device through the first coil 211-1 or when the second power is wirelessly transmitted to the external electronic device through the first coil 211-1 and second coil 211-2, connected in parallel.

According to an embodiment of the disclosure, one end of the switch 211-7 may be connected to the second coil 211-2, and the other end may be connected to the MFC IC 214. According to an embodiment of the disclosure, the switch 211-7 may perform a switch on/off operation according to the control of the processor (e.g., the processor 120 of FIG. 1 or the processor 220 of FIG. 2) or/and the MFC IC 214.

Referring to FIG. 4A, in the switch-on state of the switch 211-7, the first coil 211-1 and the second coil 211-2 connected in parallel may be connected to the MFC IC 214 to be used as a coil for wireless power transmission. Referring to FIG. 4B, in the switch-off state of the switch 211-7, the first coil 211-1 may be connected to the MFC IC 214 to be used as a coil for ping signal transmission or a coil for wireless power transmission.

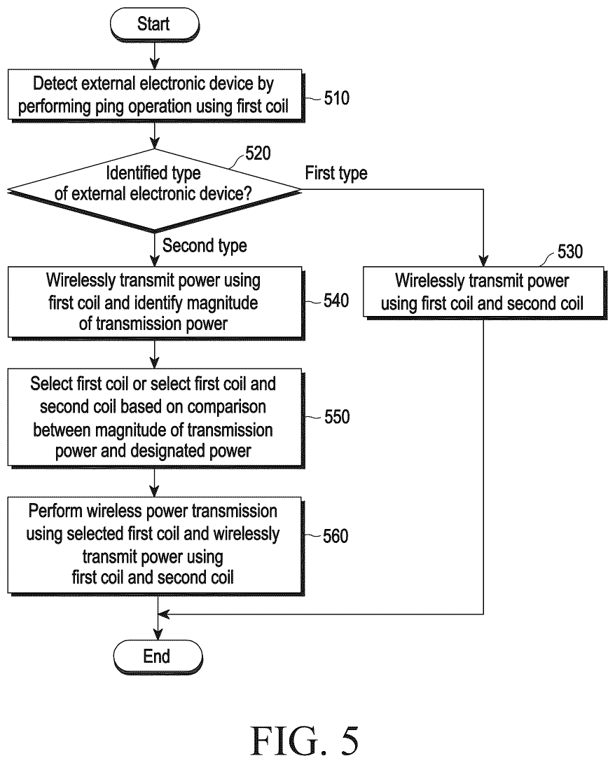

FIG. 5 is a flowchart illustrating a wireless power transmission method using multiple coils in an electronic device according to an embodiment of the disclosure.

Referring to FIG. 5, according to an embodiment of the disclosure, a processor (e.g., the processor 120 of FIG. 1 or the processor 220 of FIG. 2) of an electronic device (e.g., the electronic device 101 of FIG. 1 or the electronic device 201 of FIG. 2) may perform at least one of operations 510 to 560.

In operation 510, the processor 220 according to an embodiment may perform a ping operation using the first coil 211-1 to detect (or sense) an external electronic device (e.g., the external electronic device 102 of FIG. 1). For example, the processor 220 may control the MFC IC 214 to output a ping signal through the first coil 211-1 and detect (or sense) an external electronic device 102 (or presence of an external electronic device) based on reception of a response (e.g., reception (or detection) of a signal strength packet (SSP)) corresponding to the ping signal. For example, the processor 220 may output the ping signal through the first coil 211-1 (e.g., some coils in the center among the multiple coils), thereby reducing the area where the ping signal is recognizable by the external electronic device 102 while making the area closer to the center than when outputting the ping signal through the first coil 211-1 and the second coil 211-2 (e.g., all of the multiple coils). Accordingly, the processor 220 may increase the recognizability of an external electronic device closer to the multiple coils (or the center of the multiple coils) than an external electronic device far from the multiple coils (or the center of the multiple coils).

In operation 520, the processor 220 according to an embodiment may identify the type of the detected external electronic device. For example, the processor 220 may identify whether the external electronic device is a first-type external electronic device that receives wireless power using a coil having a first size or a second-type external electronic device that receives wireless power using a coil having a second size. For example, the first-type external electronic device may be an external electronic device (e.g., a first external electronic device or a smart phone) having the first size, and the second-type external electronic device may be an external electronic device (e.g., a second external electronic device or an accessory device or a smart watch or a wireless earphone) having a coil size smaller than the first size. For example, the first size may be similar to or the same as the sum of the sizes of the first coil 211-1 and the second coil 211-2 within a designated range. For example, the second size may be similar to or the same as the size of the first coil 211-1 within a designated range. For example, the processor 220 may identify the type of the external electronic device 102 using the external electronic device ID and/or information associated with the size of the coil (or reception coil) of the external electronic device, or may identify the type of the external electronic device 102 using a Q factor. The processor 220 may identify the type of the external electronic device 102 in other ways. According to an embodiment of the disclosure, the processor 220 may perform operation 530 when the type of the external electronic device is the first type and perform operations 540 to 560 when the type of the external electronic device is the second type.

In operation 530, the processor 220 according to an embodiment may perform wireless power transmission using the first coil 211-1 and the second coil 211-2 when the type of the external electronic device is the first type. For example, when the type of the external electronic device 102 is the first type, the processor 220 may control to wirelessly transmit power using the first coil 211-1 and the second coil 211-2. For example, when the external electronic device 102 is a first-type external electronic device including a coil having a size similar within a designated range or identical to the sum of the sizes of the first coil 211-1 and the second coil 211-2, the processor 220 may identify (or select) the first coil 211-1 and the second coil 211-2 as coils to transmit wireless power and control to wirelessly transmit power using the first coil 211-1 and the second coil 211-2.

In operation 540, when the type of the external electronic device 102 is the second type, the processor 220 may wirelessly transmit power using the first coil 211-1, and may identify the magnitude of the transmission power when transmitting wireless power using the first coil 211-1. For example, the processor 220 may adjust the magnitude of the transmission power by adjusting the operating frequency and the operating voltage in a designated frequency range (fLkHz to fHkHz) (e.g., 100 kHz to 196 kHz, 110 kHz to 148 kHz, or other operating frequency ranges) and in a designated operating voltage range (e.g., 5 v to 9 v or other operating voltage ranges) according to a request for increasing or decreasing transmission power from the external electronic device after or during wireless power transmission. For example, when decreasing the operating frequency in the designated frequency range and increasing the operating voltage in the designated operating voltage range, the processor 220 may increase the magnitude of transmission power and, when increasing the operating frequency in the designated frequency range and decreasing the operating voltage in the designated operating voltage range, decrease the magnitude of the transmission power. For example, the external electronic device 102 does not receive as much power as desired due to a state of being misaligned with the electronic device 201, the external electronic device 102 may transmit a transmission power increase request signal to the electronic device 201, and the processor 220 may increase the magnitude of transmission power by controlling to decrease the operating frequency in the designated frequency range and increase the operating voltage in the designated operating voltage range according to the transmission power increase request signal from the external electronic device 102.

In operation 550, the processor 220 according to an embodiment may select the first coil 211-1 or select the first coil 211-1 and the second coil 211-2 based on comparison between the magnitude of the transmission power identified during wireless power transmission using the first coil 211-1 and the designated power threshold. For example, the designated power threshold may be a predetermined power threshold to determine whether the electronic device 201 and the external electronic device of the second type are misaligned (by experiment or calculation) when wireless power is transmitted from the electronic device 201 to the external electronic device of the second type. For example, when the electronic device 201 and the second-type external electronic device are misaligned, the external electronic device 102 may request to increase transmission power, and the electronic device may increase the transmission power to a value larger than the power threshold. For example, the processor 220 may determine (or identify) that the electronic device 201 and the second-type external electronic device are misaligned when the magnitude of the identified transmission power is larger than the designated power threshold when transmitting wireless power using the first coil 211-1. For example, if the magnitude of transmission power identified during wireless power transmission using the first coil 211-1 is the designated power threshold or less, the processor 220 may determine (or identify) that the electronic device 201 and the second-type external electronic device are not misaligned. According to an embodiment of the disclosure, the processor 220 may adjust the operating frequency and/or operating voltage to increase the magnitude of the transmission power and may thus compare the magnitude of the operating frequency and/or the magnitude of the operating voltage with the designated frequency threshold and/or the designated voltage threshold, rather than comparing the magnitude of transmission power with the designated power threshold, when transmitting wireless power from the electronic device 201 to the second-type external electronic device. For example, each of the designated voltage threshold and/or the designated frequency threshold may be a predetermined voltage threshold and/or frequency threshold to determine whether the electronic device and the second-type external electronic device are misaligned (by experiment or calculation) when transmitting wireless power from the electronic device 201 to the second-type external electronic device. For example, when the electronic device 201 and the second-type external electronic device are misaligned, the second-type external electronic device may request to increase transmission power, and the processor 220 may decrease the operating frequency, or increase the operating voltage, or decrease the operating frequency while increasing the operating voltage so as to increase transmission power. For example, the processor 220 may determine (or identify) that the electronic device 201 and the second-type external electronic device are misaligned when the operating frequency identified during wireless power transmission using the first coil 211-1 is lower than the designated frequency threshold, or the operating voltage identified during wireless power transmission using the first coil 211-1 is higher than the designated voltage threshold, or the operating frequency identified during wireless power transmission using the first coil 211-1 is lower than the designated frequency threshold and the operating voltage is higher than the designated operating voltage threshold. For example, the processor 220 may determine (or identify) that the electronic device 201 and the second-type external electronic device are not misaligned when the operating frequency identified during wireless power transmission using the first coil 211-1 is the designated frequency threshold or more, or the operating voltage identified during wireless power transmission using the first coil 211-1 is the designated voltage threshold or less, or the operating frequency identified during wireless power transmission using the first coil 211-1 is the designated frequency threshold or more and the operating voltage is the designated operating voltage threshold or less.

The processor 220 according to an embodiment may select the first coil 211-1, or the first coil 211-1 and the second coil 211-2, as a coil for wireless power transmission to the second-type external electronic device based on a result of comparison between the magnitude of the transmission power identified during wireless power transmission using the first coil 211-1 and the designated power threshold. For example, since the processor 220 may determine (or identify) that the electronic device 201 and the second-type external electronic device are misaligned if the magnitude of the transmission power identified during wireless power transmission using the first coil 211-1 is larger than the designated power threshold, the processor 220 may select the first coil 211-1 and the second coil 211-1 as coils for wireless power transmission so that the wireless charging area is relatively increased. For example, since the processor 220 may determine (or identify) that the electronic device 201 and the second-type external electronic device are not misaligned if the magnitude of the transmission power identified during wireless power transmission using the first coil 211-1 is the designated power threshold or less, the processor 220 may select the first coil 211-1 as a coil for wireless power transmission so that the wireless charging area is maintained.

According to an embodiment of the disclosure, when the processor 220 compares the magnitude of the operating frequency and/or the magnitude of the operating voltage with the designated frequency threshold and/or designated voltage threshold rather than comparing the magnitude of transmission power with the designated power threshold during wireless power transmission to the second-type external electronic device, the processor 220 may select the first coil 211-1, or the first coil 211-1 and the second coil 211-2, as the coil for wireless power transmission based on the comparison result. For example, since the processor 220 may determine (or identify) that the electronic device 201 and the second-type external electronic device are misaligned when the operating frequency identified during wireless power transmission using the first coil 211-1 is lower than the designated frequency threshold, or the operating voltage identified during wireless power transmission using the first coil 211-1 is higher than the designated voltage threshold, or the operating frequency identified during wireless power transmission using the first coil 211-1 is lower than the designated frequency threshold and the operating voltage is higher than the designated operating voltage threshold, the processor 220 may select the first coil 211-1 and the second coil 211-2 as the coil for wireless power transmission so that the wireless charging area is relatively increased. For example, since the processor 220 may determine (or identify) that the electronic device 201 and the second-type external electronic device are not misaligned when the operating frequency identified during wireless power transmission using the first coil 211-1 is the designated frequency threshold or more, or the operating voltage identified during wireless power transmission using the first coil 211-1 is the designated voltage threshold or less, or the operating frequency identified during wireless power transmission using the first coil 211-1 is the designated frequency threshold or more and the operating voltage is the designated operating voltage threshold or less, the processor 220 may select the first coil 211-1 as the coil for wireless power transmission so that the wireless charging area is maintained.

In operation 560, the processor 220 according to an embodiment may perform wireless power transmission using the selected first coil 211-1 or perform wireless power transmission using the selected first coil 211-1 and second coil 211-2.

According to various embodiments of the disclosure, a method for transmitting wireless power based on multiple coils in an electronic device (e.g., the electronic device 101 of FIG. 1 or the electronic device 201 of FIG. 2) may comprise detecting an external electronic device by performing a ping operation using a first coil of the first coil (the first coil 211-1 of FIG. 2) and a second coil (e.g., the second coil 211-2 of FIG. 2), identifying a type of the detected external electronic device (e.g., the external electronic device 102 of FIG. 1), when the external electronic device is an external electronic device of a first type, wirelessly transmitting power to the external electronic device using the first coil and the second coil, and when the external electronic device is an external electronic device of a second type, wirelessly transmitting power through the first coil, identifying a magnitude of transmission power transmitted through the first coil, selecting the first coil or selecting the first coil and the second coil based on comparing the magnitude of the transmission power with a designated power threshold, and wirelessly transmitting power to the external electronic device using the first coil or wirelessly transmitting power to the external electronic device using the first coil and second coil.

According to various embodiments of the disclosure, the method may further comprise, when the external electronic device is the external electronic device of the second type, wirelessly transmitting the power through the first coil to identify an operating frequency associated with the magnitude of the transmission power transmitted through the first coil and selecting the first coil or selecting the first coil and the second coil based on comparing a magnitude of the operating frequency with a designated operating frequency.

According to various embodiments of the disclosure, the method may further comprise, when the external electronic device is the external electronic device of the second type, wirelessly transmitting the power through the first coil, identifying an operating voltage associated with the magnitude of the transmission power transmitted through the first coil and selecting the first coil or selecting the first coil and the second coil based on comparing a magnitude of the operating voltage with a designated operating voltage.

According to various embodiments of the disclosure, the method may further comprise, when the external electronic device is the external electronic device of the second type, wirelessly transmitting the power through the first coil, identifying an operating voltage and an operating frequency associated with the magnitude of the transmission power transmitted through the first coil and selecting the first coil or selecting the first coil and the second coil based on comparing a magnitude of the operating voltage with a magnitude of the operating frequency and a designated operating voltage and a designated operating frequency.

According to various embodiments of the disclosure, in the method, the external electronic device of the first type may include a coil of a first size, and the external electronic device of the second type includes a coil of a second size smaller than the first size.

According to various embodiments of the disclosure, in the method, the first coil may be a circular coil, and the second coil may be a circular coil surrounding an outside of the first coil.

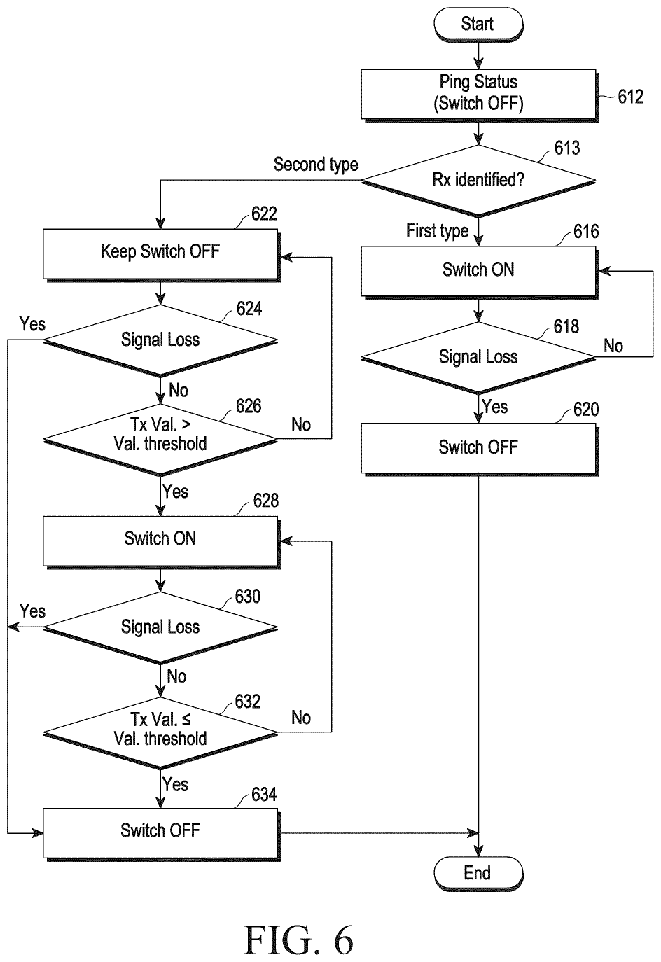

FIG. 6 is a flowchart illustrating a switch control operation when an electronic device transmits wireless power using multiple coils according to an embodiment of the disclosure.

Referring to FIG. 6, according to an embodiment of the disclosure, a processor (e.g., the processor 120 of FIG. 1 or the processor 220 of FIG. 2) of an electronic device (e.g., the electronic device 101 of FIG. 1 or the electronic device 201 of FIG. 2) may perform at least one of operations 612 to 634.

In operation 612, the processor 220 according to an embodiment may detect (or sense) an external electronic device by performing a ping operation using the first coil 211-1 in a state in which the switch 211-7 is off (Ping status (switch off)). For example, the processor 220 may control the MFC IC 214 to output a ping signal through the first coil 211-1 in a state in which the switch 211-7 is off, and detect (or sense) an external electronic device (e.g., wireless power reception device Rx) (e.g., the external electronic device 102 of FIG. 1) (or presence of an external electronic device) based on reception of a response (e.g., reception (or detection) of a signal strength packet (SSP)) corresponding to the ping signal. For example, the processor 220 may output a ping signal using the first coil 211-1 (e.g., some coils in the center among the multiple coils) so that the strength of the ping signal is weaker than when outputting the ping signal using the first coil 211-1 and the second coil 211-2 (e.g., all of the multiple coils), allowing an external electronic device closer to the multiple coils (or the center of the multiple coils) (or an external electronic device having a lower chance of misalignment) to be recognized rather than an external electronic device far from the multiple coils (or the center of the multiple coils) (or an external electronic device having a higher chance of misalignment).

In operation 613, the processor 220 according to an embodiment may identify the type of the detected external electronic device 102 (identify Rx). For example, the processor 220 may identify whether the external electronic device is a first-type external electronic device that receives wireless power using a coil having a first size or a second-type external electronic device that receives wireless power using a coil having a second size. For example, the first-type external electronic device may be an external electronic device (e.g., a first external electronic device or a smart phone) having the first size, and the second-type external electronic device may be an external electronic device (e.g., a second external electronic device or an accessory device or a smart watch or a wireless earphone) having a second size smaller than the first size. For example, the first size may be similar to or the same as the sum of the sizes of the first coil 211-1 and the second coil 211-2 within a designated range. For example, the second size may be similar to or the same as the size of the first coil 211-1 within a designated range. For example, the processor 220 may identify the type of the external electronic device 102 using the external electronic device ID and/or information associated with the size of the coil (or reception coil) of the external electronic device, or may identify the type of the external electronic device 102 using a Q factor. The processor 220 may identify the type of the external electronic device 102 in other ways. According to an embodiment of the disclosure, the processor 220 may perform operations 616 to 620 when the type of the external electronic device is the first type and perform operations 622 to 634 when the type of the external electronic device is the second type.

In operation 616, when the type of the external electronic device is the first type, the processor 220 according to an embodiment may control the switch 211-7 to switch on to connect the first coil 211-1 and the second coil 211-2 to the MFC IC 214 and control to perform wireless power transmission using the first coil 211-1 and the second coil 211-2 (switch on).

In operation 618, the processor 220 according to an embodiment may identify whether connection with the first-type external electronic device is terminated or power transmission to the first-type external electronic device is terminated (Signal loss). The processor 220 according to an embodiment may continue wireless power transmission using the first coil 211-1 and the second coil 211-2 if connection with the first-type external electronic device is not terminated or power transmission to the first-type external electronic device is not terminated.

In operation 620, if connection with the first-type external electronic device is terminated or power transmission to the first-type external electronic device is terminated, the processor 220 according to an embodiment may control the switch 211-7 to switch off to connect the first coil 211-1 to the MFC IC 214 and terminate (switch off) or may return to the standby state (or standby mode or ping status) in operation 612.

In operation 622, when the type of the external electronic device is the second type, the processor 220 according to an embodiment may wirelessly transmit power using the first coil 211-1 in a state in which the switch 211-7 remains off (keep switch off). For example, the processor 220 may identify (or monitor) the magnitude of the operating voltage and the operating frequency associated with wireless power transmission while wirelessly transmitting power using the first coil 211-1 in a state in which the switch 211-7 remains off. For example, the processor 220 may adjust the magnitude of the transmission power by adjusting the operating frequency and the operating voltage in a designated frequency range (fLkHz to fHkHz) (e.g., 100 kHz to 196 kHz, 110 kHz to 148 kHz, or other operating frequency ranges) and in a designated operating voltage range (e.g., 5 v to 9 v or other operating voltage ranges) according to a request for increasing or decreasing transmission power from the second-type external electronic device after or during wireless power transmission, and may identify the adjusted operating frequency and operating voltage. For example, when decreasing the operating frequency in the designated frequency range and increasing the operating voltage in the designated operating voltage range, the processor 220 may increase the magnitude of transmission power and, when increasing the operating frequency in the designated frequency range and decreasing the operating voltage in the designated operating voltage range, decrease the magnitude of the transmission power. For example, the external electronic device 102 does not receive as much power as desired due to a state of being misaligned with the electronic device 201, the external electronic device 102 may transmit a transmission power increase request signal to the electronic device 201, and the processor 220 may increase the magnitude of transmission power by controlling to decrease the operating frequency in the designated frequency range and increase the operating voltage in the designated operating voltage range according to the transmission power increase request signal from the external electronic device 102.

In operation 624, the processor 220 according to an embodiment may identify whether connection with the second-type external electronic device is terminated or power transmission to the second-type external electronic device is terminated (Signal loss). When connection with the second-type external electronic device is terminated or power transmission to the second-type external electronic device is terminated, the processor 220 according to an embodiment may proceed to operation 634. When connection with the second-type external electronic device is not terminated, and power transmission to the second-type external electronic device is not terminated, the processor 220 according to an embodiment may perform operation 626.

In operation 626, the processor 220 according to an embodiment may identify (or determine) whether the magnitude of transmission power during wireless power transmission to the second-type external electronic device using the first coil 211-1 is larger than a designated power threshold (Tx val. (magnitude of transmission power)>val. Threshold (designated power threshold or designated first power threshold)). For example, the designated power threshold may be a predetermined power threshold to determine whether the electronic device and the second-type external electronic device are misaligned (by experiment or calculation) during wireless power transmission from the electronic device 201 to the second-type external electronic device using the first coil 211-1. For example, when the electronic device 201 and the second-type external electronic device are misaligned, the second-type external electronic device may request to increase transmission power, and the electronic device may increase the transmission power to a value larger than the designated power threshold. For example, the processor 220 may determine (or identify) that the electronic device and the second-type external electronic device are misaligned when the magnitude of the identified transmission power is larger than the designated power threshold when transmitting wireless power using the first coil 211-1 and proceed to operation 628. For example, the processor 220 may determine (or identify) that the electronic device and the second-type external electronic device are not misaligned if the magnitude of the transmission power identified during wireless power transmission using the first coil 211-1 is the designated power threshold or less, and the processor 220 may return to operation 622 to continue wireless power transmission using the first coil 211-1 while keeping the switch 211-7 off. According to an embodiment of the disclosure, the processor 220 may adjust the operating frequency and/or operating voltage to increase the magnitude of the transmission power and may thus compare the magnitude of the operating frequency and/or the magnitude of the operating voltage with the designated frequency threshold and/or the designated voltage threshold, rather than comparing the magnitude of transmission power with the power threshold, when transmitting wireless power from the electronic device 201 to the second-type external electronic device. For example, each of the designated voltage threshold and/or the designated frequency threshold may be a predetermined voltage threshold and/or frequency threshold to determine whether the electronic device 201 and the second-type external electronic device are misaligned (by experiment or calculation) during wireless power transmission from the electronic device 201 to the second-type external electronic device using the first coil 211-1. For example, when the electronic device 201 and the second-type external electronic device are misaligned, the second-type external electronic device may request to increase transmission power, and the processor 220 may decrease the operating frequency, or increase the operating voltage, or decrease the operating frequency while increasing the operating voltage so as to increase transmission power. For example, the processor 220 may determine (or identify) that the electronic device 201 and the second-type external electronic device are misaligned when the operating frequency identified during wireless power transmission using the first coil 211-1 is lower than the designated frequency threshold, or the operating voltage identified during wireless power transmission using the first coil 211-1 is higher than the designated voltage threshold, or the operating frequency identified during wireless power transmission using the first coil 211-1 is lower than the designated frequency threshold and the operating voltage is higher than the designated operating voltage threshold, and may proceed to operation 628. For example, the processor 220 may determine (or identify) that the electronic device 201 and the second-type external electronic device are not misaligned when the operating frequency identified during wireless power transmission using the first coil 211-1 is the designated frequency threshold or more, or the operating voltage identified during wireless power transmission using the first coil 211-1 is the designated voltage threshold or less, or the operating frequency identified during wireless power transmission using the first coil 211-1 is the designated frequency threshold or more and the operating voltage is the designated operating voltage threshold or less, and may return to operation 622 to continue wireless power transmission using the first coil 211-1 while keeping the switch 211-7 off.

In operation 628, the processor 220 according to an embodiment may turn on the switch 211-7 to connect the first coil 211-1 and the second coil 211-2 to the MFC IC 214 and wirelessly transmit power to the second-type external electronic device through the first coil 211-1 and the second coil 211-2 (switch on). For example, the wireless charging area may be relatively broader when the processor 220 transmits wireless power using the first coil 211-1 and the second coil 211-2 than when transmitting wireless power to the second-type external electronic device through the first coil 211-1, and transmission power loss due to a misalignment between the electronic device 201 and the second-type external electronic device may be reduced, thus increasing wireless power transmission efficiency.

In operation 630, the processor 220 according to an embodiment may identify whether connection with the second-type external electronic device is terminated or power transmission to the second-type external electronic device is terminated in a state in which the switch 211-7 remains on (Signal loss). The processor 220 according to an embodiment may proceed to operation 632 when connection with the second-type external electronic device is not terminated or power transmission to the second-type external electronic device is not terminated in a state in which the switch 211-7 remains on. When connection with the second-type external electronic device is terminated or power transmission to the second-type external electronic device is terminated, the processor 220 according to an embodiment may proceed to operation 634.

In operation 632, the processor 220 according to an embodiment may identify whether the magnitude of the transmission power identified during wireless power transmission to the second-type external electronic device using the first coil 211-1 and the second coil 211-2 is smaller than or equal to a designated power threshold (Tx val. (magnet of transmission power)≤val. Threshold (designated power threshold or designated second power threshold)). For example, the designated power threshold in operation 632 (e.g., the designated first power threshold) may be equal to or different, within a designated error range, from the designated power threshold (e.g., the designated second power threshold) in operation 626. For example, if the magnitude of transmission power identified during wireless power transmission to the second-type external electronic device using the first coil 211-1 and the second coil 211-2 is larger than the designated power threshold, the processor 220 may return to operation 628. For example, if the magnitude of transmission power identified during wireless power transmission to the second-type external electronic device using the first coil 211-1 and the second coil 211-2 is smaller than or equal to the designated second power threshold, the processor 220 may proceed to operation 634.

In operation 634, the processor 220 according to an embodiment may turn off the switch 211-7 to connect the first coil 211-1 to the MFC IC 214 and terminate (switch off). Or, the processor 220 according to an embodiment may turn off the switch 211-7 to connect the first coil 211-1 to the MFC IC 214 and return to operation 612.

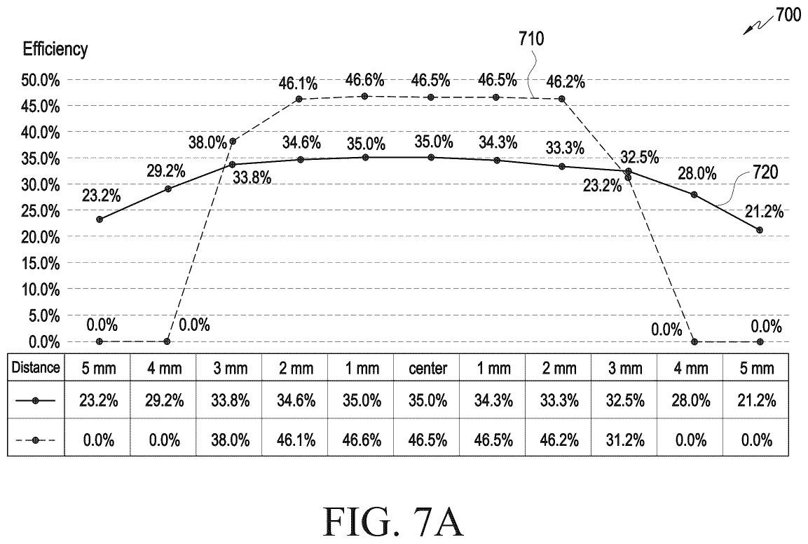

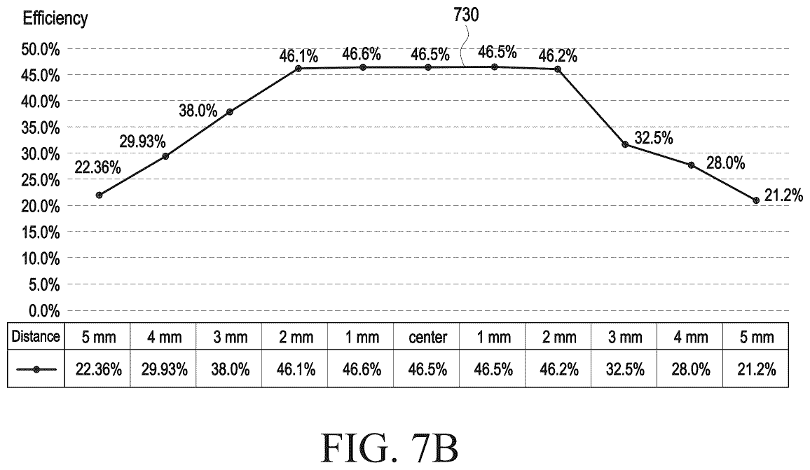

FIG. 7A is a view illustrating an efficiency characteristic when an electronic device performs wireless power transmission using a first coil 211-1 and a second coil 211-2 according to an embodiment of the disclosure.

Referring to FIG. 7A, the processor 220 according to an embodiment may obtain a graph 700 showing the power transmission efficiency depending on the distance between the external electronic device 102 and the center of the multiple coils while the electronic device (e.g., the electronic device 101 of FIG. 1 or the electronic device 201 of FIG. 2) wirelessly transmits power to the external electronic device using the first coil 211-1 and the second coil 211-2 (e.g., referred to as dual coil) and the power transmission efficiency depending on the distance between the external electronic device (e.g., the external electronic device 102 of FIG. 1) and the center of the multiple coils while the electronic device (e.g., the electronic device 101 of FIG. 1 or the electronic device 201 of FIG. 2) wirelessly transmits power to the external electronic device using the first coil 211-1. According to an embodiment of the disclosure, the horizontal axis may denote the distance between the center of the multiple coils and the external electronic device 102, and the vertical axis may denote the power transmission efficiency between the electronic device 201 and the external electronic device 102. According to an embodiment of the disclosure, a first curve graph 710 may denote the power transmission efficiency depending on the distance between the center of the multiple coils and the external electronic device 102 during wireless power transmission to the external electronic device 102 using the first coil 211-1, and a second curve graph 720 may denote the power transmission efficiency depending on the distance between the center of the multiple coils and the external electronic device 102 during wireless power transmission to the external electronic device 102 using the first coil 211-1 and the second coil 211-2. For example, when the processor 220 wirelessly transmits power to the external electronic device 102 using the first coil 211-1, according to the first curve graph 710, in a distance close to the center (e.g., when the distance from the center is about 3 mm or less), the power transmission efficiency may remain relatively high as about 32.5% to 46.5%, but the recognition area (transmission area or charging area) may be narrow. For example, when the processor 220 wirelessly transmits power to the external electronic device 102 using the first coil 211-1 and the second coil 211-2, according to the second curve graph 720, the recognition area (transmission area or charging area) up to a distance far from the center (e.g., when the distance from the center is about 5 mm or more) may be broad, but the power transmission efficiency may be lower, as about 21.2% to 35%, than when the first coil 211-1 is used.

FIG. 7B is a view illustrating an efficiency characteristic when an electronic device performs wireless power transmission by switching on or off depending on a magnitude of transmission power (or magnitude of operating frequency and/or operating voltage) to an external electronic device according to an embodiment of the disclosure.

Referring to FIG. 7B, when the processor 220 according to an embodiment wirelessly transmits power to the external electronic device 102 using the first coil 211-1 in a state in which the switch 211-7 is off, and determines whether to turn on or off the switch 211-7 according to the magnitude of transmission power (or the magnitude of operating frequency and/or operating voltage) and performs wireless power transmission, the processor 220 may obtain a result like a third curve graph 730.

For example, when the processor 220 wirelessly transmits power to the external electronic device 102 using the first coil 211-1 in a state in which the switch 211-7 is off, and determines whether to turn on or off the switch 211-7 according to the magnitude of transmission power (or the magnitude of operating frequency and/or operating voltage) and performs wireless power transmission, like in the third curve graph 730, the recognition area and efficiency may be enhanced as compared with the first curve graph 710 and the second graph 720, maintaining stability during power transmission (or during charging).

According to an embodiment of the disclosure, if the processor 220 performs a ping operation using the first coil 211-1 and the second coil 211-2, the probability of detecting an external electronic device present at the periphery far from the center of the multiple coils may be higher than when a ping operation is performed using the first coil 211-1 and, in a state in which an external electronic device present at the periphery far from the center of the multiple coils is detected, the coupling (power transmission efficiency) between the coil of the electronic device and the coil of the external electronic device may be highly likely to deteriorate. Thus, although the electronic device transmits maximum power, the power received by the external electronic device may be small. According to an embodiment of the disclosure, if the processor 220 performs a ping operation using the first coil 211-1, the probability of detecting an external electronic device close to the center of the multiple coils may be higher than when a ping operation is performed using the first coil 211-1 and the second coil 211-2 and, in a state in which an external electronic device close to the center of the multiple coils is detected, the coupling (power transmission efficiency) between the coil of the electronic device and the coil of the external electronic device may be high.

Table 1 below is a table showing the difference in reception power between the outer area with respect to the first coil 211-1 when performing the ping operation using the first coil 211-1 and the outer area with respect to the first coil 211-1 and the second coil 211-2 when performing the ping operation using the first coil 211-1 and the second coil 211-2.

TABLE 1

| | | | Rx | |
|---|---|---|---|---|
| | | | reception | |
| Ping | Voltage | Current | Power | |
| operation | (V) | (A) | (W) | Description |
| Ping operation | About | About | About | Re-recognition may |
| using first coil | 4.94 | 0.314 | 1.55 | repeat due to packet |
| 211-1 and | | | | loss in outer area |
| second coil | | | | of first coil 211-1 |
| 211-2 | | | | and second coil 211-2, |
| | | | | and magnitude of Rx |
| | | | | reception power is low |
| Ping operation | About | About | About | Packet loss is small in |
| using first | 5.42 | 0.682 | 3.69 | outer area of first coil |
| coil 211-1 | | | | 211-1, and magnitude of |
| | | | | reception power is large |

Referring to Table 1, the outer area with respect to the first coil 211-1 when the processor 220 performs the ping operation using the first coil 211-1 may be closer to the center of the multiple coils than the outer area with respect to the first coil 211-1 and the second coil 211-2 when performing the ping operation using the first coil 211-1 and the second coil 211-2. According to an embodiment of the disclosure, when the processor 220 performs the ping operation using the first coil 211-1, packet loss is small and the magnitude of reception power is large in the outer area with respect to the first coil 211-1, and thus, more efficiency may be achieved than when the ping operation is performed using the first coil 211-1 and the second coil 211-2.

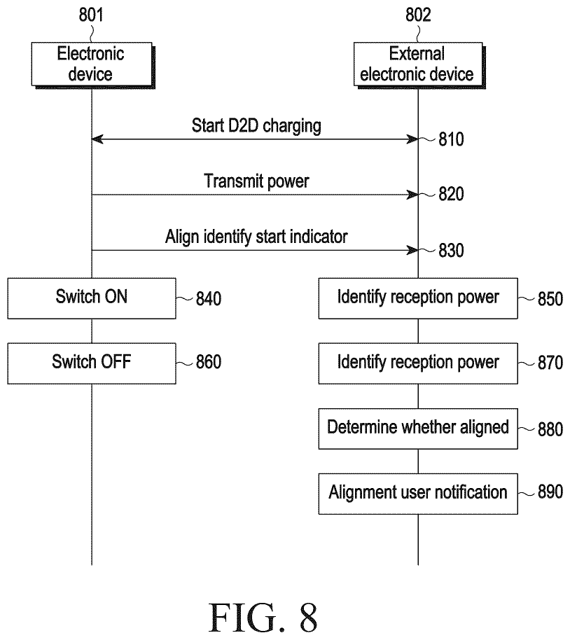

FIG. 8 is a flowchart illustrating an alignment notification operation based on identifying whether an electronic device and an external electronic device are aligned according to an embodiment of the disclosure.

Referring to FIG. 8 each of a processor (e.g., the processor 120 of FIG. 1 or the processor 220 of FIG. 2) of an electronic device (or wireless power transmission device) 801 (e.g., the electronic device 101 of FIG. 1 or the electronic device 201 of FIG. 2) according to an embodiment and an external electronic device (or wireless power reception device) 802 (e.g., the external electronic device 102 of FIG. 1) may perform at least some operations of operations 810 to 890.

In operation 810, the processor (e.g., the processor 120 of FIG. 1 or the processor 220 of FIG. 2) of the electronic device 801 according to an embodiment and the external electronic device (or wireless power reception device) 802 (e.g., the external electronic device 102 of FIG. 1 (or a processor (not shown) of the external electronic device)) may start device-to-device (D2D) charging. For example, the electronic device 801 may allow a ping signal to be periodically output through a ping operation and detect an external electronic device 802 based on detecting a response (e.g., a signal strength packet (SSP)) corresponding to the ping signal from the external electronic device 802, and the electronic device 801 may perform an authentication operation based on detection of the external electronic device 802.

In operation 820, the electronic device 801 according to an embodiment may start wireless power transmission using the first coil 211-1 and/or the second coil 211-2 based on completion of the authentication operation with the external electronic device 802.

In operation 830, the electronic device 801 may transmit, to the external electronic device 802, alignment state identify start identification information (e.g., align identify start indicator) for identifying the alignment state of the external electronic device 802 based on start of wireless power transmission, a designated condition during wireless power transmission, or an alignment state identify request from the external electronic device 802. For example, the electronic device 801 and the external electronic device 802 may use packets, procedures, and/or timings pre-agreed therebetween. When receiving the alignment state identify start identification information, the external electronic device 802 may respond to the electronic device 801 with information indicating that the identification information is received.

In operation 840, the electronic device 801 according to an embodiment may transmit first power through the first coil 211-1 and the second coil 211-2 in a state in which the switch 211-7 is turned on after transmitting the alignment state identify start identification information or when receiving the response signal according to transmission of the alignment state identify start identification information (switch on).

In operation 850, the external electronic device 702 according to an embodiment may identify the reception power (e.g., magnitude of first reception power) by the first power transmitted through the first coil 211-1 and the second coil 211-2.

In operation 860, the electronic device 701 according to an embodiment may transmit second power through the first coil 211-1 in a state in which the switch 211-7 is turned off after transmitting the first power (switch off).

In operation 870, the external electronic device 802 according to an embodiment may identify the reception power (e.g., the magnitude of the second reception power) by the second power transmitted through the first coil 211-1.

In operation 880, the external electronic device 802 according to an embodiment may identify whether it is aligned with the electronic device 801 based on the magnitude of the first reception power and the magnitude of the second reception power. For example, when the magnitude of the first reception power or the magnitude of the second reception power is equal to or less than (or less than) a predetermined threshold lower limit power amount, the external electronic device 102 may identify that the electronic device 201 and the external electronic device are misaligned.

Table 2 below may be a table showing an example for describing the threshold lower limit power amount according to an embodiment.

TABLE 2

| | | On | Off |
|---|---|---|---|
| | | (magnitude of | (magnitude of |
| Type of external | | first reception | second reception |
| electronic device | Switch | power) | power) |
| Second type | align | first power | second power amount |
| (e.g., watch) | | amount range | range |
| | mis-align | third power | fourth power amount |
| | | amount range | range (threshold low |
| | | | limit power amount) |
| first type | align | fifth power | sixth power amount |
| (e.g., Phone) | | amount range | range |
| | mis-align | seventh power | eighth power amount |
| | | amount range | range |

Referring to Table 2 above, when the external electronic device 802 according to an embodiment is a second-type external electronic device, if the electronic device 801 is performing wireless power transmission in a switch-on state, and the electronic device 801 and the second-type external electronic device are aligned, the power received by the second-type external electronic device may be included in a first power amount range (e.g., about 0.74 w). If the electronic device 801 is performing wireless power transmission in a switch-off state, and the electronic device 801 and the second-type external electronic device are aligned, the power received by the second-type external electronic device may be included in a second power amount range that is equal to or larger, within a slight error range, than the first power amount range. If the electronic device 801 is performing wireless power transmission in a switch-on state, and the electronic device 801 and the second-type external electronic device are misaligned, the power received by the second-type external electronic device may be included in a third power amount range that is equal to or smaller, within a slight error range, than the first power amount range. For example, if the electronic device 801 is performing wireless power transmission in a switch-off state, and the electronic device 801 and the second-type external electronic device are misaligned, the power received by the second-type external electronic device may be included in equal to or less than a fourth power amount range smaller than the first power amount range to fall outside the error range. For example, the fourth power amount range may include a second threshold lower limit power amount range or a second threshold lower limit power amount for the second-type external electronic device. When the external electronic device 802 according to an embodiment is a first-type external electronic device, if the electronic device 801 is performing wireless power transmission in a switch-on state, and the electronic device 801 and the first-type external electronic device are aligned, the power received by the first-type external electronic device may be included in a fifth power amount range (e.g., a power amount range larger than the first power amount range). If the electronic device 801 is performing wireless power transmission in a switch-off state, and the electronic device 801 and the first-type external electronic device are aligned, the power received by the first-type external electronic device may be included in a sixth power amount range that is equal to or larger, within a slight error range, than the fifth power amount range. If the electronic device 801 is performing wireless power transmission in a switch-on state, and the electronic device 801 and the first-type external electronic device are misaligned, the power received by the first-type external electronic device may be included in a seventh power amount range that is equal to or smaller, within a slight error range, than the fifth power amount range. For example, if the electronic device 801 is performing wireless power transmission in a switch-off state, and the electronic device 801 and the first-type external electronic device are misaligned, the power received by the first-type external electronic device may be included in equal to or less than an eighth power amount range smaller than the first power amount range to fall outside the error range. For example, the eighth power amount range may include a first threshold lower limit power amount range or a first threshold lower limit power amount for the first-type external electronic device. According to various embodiments of the disclosure, the threshold lower limit power amount range or the threshold lower limit power amount may have various values depending on the type (or kind) of the external electronic device. For example, when the external electronic device 102 is a first-type external electronic device, if the magnitude of the first reception power or the magnitude of the second reception power is equal to or less than (or less than) a predetermined first threshold lower limit power amount, the external electronic device 102 may identify that the electronic device 201 and the first-type external electronic device are misaligned. For example, when the external electronic device 102 is a second-type external electronic device, if the magnitude of the first reception power or the magnitude of the second reception power is equal to or less than (or less than) a predetermined second threshold lower limit power amount, the external electronic device 102 may identify that the electronic device 201 and the second-type external electronic device are misaligned.

In operation 890, the external electronic device 802 according to an embodiment may notify the user whether it is aligned with the electronic device 801 based on a result of identifying whether it is aligned with the electronic device 801. For example, the external electronic device 802 may display, on the display, information indicating whether the external electronic device 802 is aligned or misaligned with the electronic device 801 or output, through the speaker, a sound corresponding to the information indicating whether the external electronic device 802 and the electronic device 801 are aligned or misaligned.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

According to various embodiments of the disclosure, in a non-transitory storage medium storing instructions that, the instructions configured to, when executed by at least one processor included in an electronic device, cause the electronic device to perform at least one operation, the at least one operation may comprise detecting an external electronic device by performing a ping operation using a first coil of the first coil and a second coil, identifying a type of the detected external electronic device, when the external electronic device is an external electronic device of a first type, wirelessly transmitting power to the external electronic device using the first coil and the second coil, and when the external electronic device is an external electronic device of a second type, wirelessly transmitting power through the first coil, identifying a magnitude of transmission power transmitted through the first coil, selecting the first coil or selecting the first coil and the second coil based on comparing the magnitude of the transmission power with a designated power threshold, and wirelessly transmitting power to the external electronic device using the first coil or wirelessly transmitting power to the external electronic device using the first coil and second coil.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a battery;
multi-coil circuitry including a first coil and a second coil;
magnetic field control circuitry electrically connected to the multi-coil circuitry;
a power management module electrically connected to the battery and the magnetic field control circuitry;
memory storing one or more computer programs; and
one or more processors communicatively coupled to the battery, the multi-coil circuitry, the magnetic field control circuitry, the power management module, and the memory,
wherein the one or more computer programs include computer-executable instructions that, when executed by the one or more processors individually or collectively, cause the electronic device to:
detect an external electronic device by performing a ping operation using the first coil and identify a type of the detected external electronic device,
when the external electronic device is an external electronic device of a first type, wirelessly transmit power to the external electronic device using the first coil and the second coil, and
when the external electronic device is an external electronic device of a second type, wirelessly transmit power through the first coil, identify a magnitude of transmission power transmitted through the first coil, select the first coil or select the first coil and the second coil based on comparing the magnitude of the transmission power with a designated power threshold, and wirelessly transmit power to the external electronic device using the first coil or wirelessly transmit power to the external electronic device using the first coil and second coil.

2. The electronic device of claim 1, wherein the one or more computer programs further include computer-executable instructions that, when executed by the one or more processors individually or collectively, cause the electronic device to:
when the external electronic device is the external electronic device of the second type, wirelessly transmit the power through the first coil, identify an operating frequency associated with the magnitude of the transmission power transmitted through the first coil, and
select the first coil or select the first coil and the second coil based on comparing a magnitude of the operating frequency with a designated operating frequency.

3. The electronic device of claim 1, wherein the one or more computer programs further include computer-executable instructions that, when executed by the one or more processors individually or collectively, cause the electronic device to:
when the external electronic device is the external electronic device of the second type, wirelessly transmit the power through the first coil, identify an operating voltage associated with the magnitude of the transmission power transmitted through the first coil, and
select the first coil or select the first coil and the second coil based on comparing a magnitude of the operating voltage with a designated operating voltage.

4. The electronic device of claim 1, wherein the one or more computer programs further include computer-executable instructions that, when executed by the one or more processors individually or collectively, cause the electronic device to:
when the external electronic device is the external electronic device of the second type, wirelessly transmit the power through the first coil, identify an operating voltage and an operating frequency associated with the magnitude of the transmission power transmitted through the first coil, and
select the first coil or select the first coil and the second coil based on comparing a magnitude of the operating voltage and a magnitude of the operating frequency, with a designated operating voltage and a designated operating frequency.

5. The electronic device of claim 1, wherein the external electronic device of the first type includes a coil of a first size, and the external electronic device of the second type includes a coil of a second size smaller than the first size.

6. The electronic device of claim 1, wherein the first coil is a circular coil, and the second coil is a circular coil surrounding an outside of the first coil.

7. The electronic device of claim 1,
wherein one end of the first coil and the other end of the first coil are connected to the magnetic field control circuitry, and the one end of the first coil is connected to the second coil,
wherein one end of the second coil is connected to the one end of the first coil, and the other end of the second coil is connected to a switch, and
wherein one end of the switch is connected to the other end of the second coil, and the other end of the switch is connected to the magnetic field control circuitry.

8. The electronic device of claim 7, wherein the one or more computer programs further include computer-executable instructions that, when executed by the one or more processors individually or collectively, cause the electronic device to:
control the switch to switch off so that the first coil and second coil connected in parallel are connected to the magnetic field control circuitry, and
control the switch to switch on so that the first coil is connected to the magnetic field control circuitry.

9. The electronic device of claim 1, wherein the one or more computer programs further include computer-executable instructions that, when executed by the one or more processors individually or collectively, cause the electronic device to:
based on receiving request information to identify an alignment state between the electronic device and the external electronic device from the external electronic device during wirelessly transmitting power to the external electronic device, transmit response information in response to the request information to the external electronic device,
control a switch to switch on during a first time period after transmitting the response information to the external electronic device to wirelessly transmit power through the first coil and the second coil, and
control the switch to switch off during a second time period after the first time period to wirelessly transmit power through the first coil.

10. The electronic device of claim 1, wherein the one or more computer programs further include computer-executable instructions that, when executed by the one or more processors individually or collectively, cause the electronic device to:
based on receiving response information in response to request information to identify an alignment state between the electronic device and another external electronic device from the another external electronic device during wirelessly transmitting power to the another external electronic device, identify a magnitude of first power received during a first time period and a magnitude of second power received during a second time period after the first time period, and
identify whether the electronic device is in a state of being aligned or misaligned with the another external electronic device based on comparing the magnitude of the first power or the magnitude of the second power with a designated power.

11. The electronic device of claim 10, further comprising:
a display,
wherein the one or more computer programs further include computer-executable instructions that, when executed by the one or more processors individually or collectively, cause the electronic device to:
when identifying that the electronic device is in the state of being misaligned with the another external electronic device, display, on the display, information indicating misaligned state.

12. The electronic device of claim 10, further comprising:
a speaker,
wherein the one or more computer programs further include computer-executable instructions that, when executed by the one or more processors individually or collectively, cause the electronic device to:
when identifying that the electronic device is in the state of being misaligned with the another external electronic device, output, through the speaker, a sound corresponding to information indicating misaligned state.

13. A method for transmitting wireless power based on multi-coil in an electronic device, the method comprising:
detecting an external electronic device by performing a ping operation using a first coil of the first coil and a second coil;
identifying a type of the detected external electronic device;
when the external electronic device is an external electronic device of a first type, wirelessly transmitting power to the external electronic device using the first coil and the second coil; and
when the external electronic device is an external electronic device of a second type, wirelessly transmitting power through the first coil, identifying a magnitude of transmission power transmitted through the first coil, selecting the first coil or selecting the first coil and the second coil based on comparing the magnitude of the transmission power with a designated power threshold, and wirelessly transmitting power to the external electronic device using the first coil or wirelessly transmitting power to the external electronic device using the first coil and second coil.

14. The method of claim 13, further comprising:
when the external electronic device is the external electronic device of the second type, wirelessly transmitting the power through the first coil, identify an operating frequency associated with the magnitude of the transmission power transmitted through the first coil; and
selecting the first coil or select the first coil and the second coil based on comparing a magnitude of the operating frequency with a designated operating frequency.

15. The method of claim 13, further comprising:
when the external electronic device is the external electronic device of the second type, wirelessly transmitting the power through the first coil, identify an operating voltage associated with the magnitude of the transmission power transmitted through the first coil; and
selecting the first coil or selecting the first coil and the second coil based on comparing a magnitude of the operating voltage with a designated operating voltage.

16. The method of claim 13, further comprising:
when the external electronic device is the external electronic device of the second type, wirelessly transmitting the power through the first coil, identify an operating voltage and an operating frequency associated with the magnitude of the transmission power transmitted through the first coil; and
selecting the first coil or selecting the first coil and the second coil based on comparing a magnitude of the operating voltage and a magnitude of the operating frequency, with a designated operating voltage and a designated operating frequency.

17. The method of claim 13, wherein the external electronic device of the first type includes a coil of a first size, and the external electronic device of the second type includes a coil of a second size smaller than the first size.

18. The method of claim 13, wherein the first coil is a circular coil, and the second coil is a circular coil surrounding an outside of the first coil.

19. One or more non-transitory computer-readable storage media storing computer-executable instructions that, when executed by one or more processors individually or collectively included in an electronic device, cause an electronic device to perform operations, the operations comprising:
detecting an external electronic device by performing a ping operation using a first coil of the first coil and a second coil;
identifying a type of the detected external electronic device;
when the external electronic device is an external electronic device of a first type, wirelessly transmitting power to the external electronic device using the first coil and the second coil; and
when the external electronic device is an external electronic device of a second type, wirelessly transmitting power through the first coil, identifying a magnitude of transmission power transmitted through the first coil, selecting the first coil or selecting the first coil and the second coil based on comparing the magnitude of the transmission power with a designated power threshold, and wirelessly transmitting power to the external electronic device using the first coil or wirelessly transmitting power to the external electronic device using the first coil and second coil.

20. The one or more non-transitory computer-readable storage media of claim 19, the operations further comprising:
when the external electronic device is the external electronic device of the second type, wirelessly transmitting the power through the first coil, identify an operating frequency associated with the magnitude of the transmission power transmitted through the first coil; and
selecting the first coil or selecting the first coil and the second coil based on comparing a magnitude of the operating frequency with a designated operating frequency.
